(19) United States
(12) Patent Application Publication
(10) Pub. No.: US 2007/0174035 A1
(43) Pub. Date: Jul. 26, 2007

(54) Open architecture picture transfer protocol interface and related method

(75) Inventor: Shih-Fang Chuang, Hsinchu City (TW)

Correspondence Address: BACON & THOMAS, PLLC, 625 SLATERS LANE, FOURTH FLOOR, ALEXANDRIA, VA, 22314, US

(73) Assignee: ALTEK CORPORATION, Hsinchu City (TW)

(21) Appl. No.: 11/490,115

(22) Filed: Jul. 21, 2006

(30) Foreign Application Priority Data
Dec. 30, 2005 (TW) 094147417

(51) Int. Cl. G06F 9/455

(52) U.S. Cl. 703/24

(57) ABSTRACT

The present invention provides a picture transfer protocol (PTP) interface of an open architecture, which can be used on an operation interface of a digital device to enable vendors to develop vendor-defined commands by themselves. The open architecture of the picture transfer protocol includes a command interpreter which is used to execute standard commands and/or the vendor-defined commands, a command manager which is used to add or remove the standard commands and/or the vendor-defined commands, and a command set classification which is used to classify the standard commands and/or the vendor-defined commands.

### BACKGROUND OF THE INVENTION

1. Field of Invention

The present invention relates to a picture transfer protocol (PTP) interface of an open architecture, and more particularly, to an interface where vendors can develop vendor-defined commands by themselves; and it also relates to a method for allowing the insertion of vendor-defined commands, particularly to a method for providing insertion of vendor-defined commands for the open architecture PTP interface.

2. Description of the Related Art

Generally speaking, during the production and design process of digital cameras, the system development companies or related vendors usually modify the original design of the functionalities for the digital cameras to meet ultimate consumers' requirements, and the digital cameras will then be sold to the ultimate consumers after the modifications.

However, there is no convenient method to modify the PTP interface in the prior technologies; therefore system development companies or related vendors often had difficulties when it comes to design modification.

Moreover, there is no well established framework for the PTP interface in the prior technologies, so that programs in the PTP such as the generic control process, the standard commands and the vendor-defined commands are unclassified and are mixed together. As a result, there would be great difficulty if vendors require defining new commands, and it makes command maintenance a heavy burden.

Furthermore, in the prior technologies, one needs to be familiar with the programming language which is used to establish the interface structure in order to make modifications. However, ordinary engineers would not be able to modify the architecture of the digital cameras by themselves, and they would have to rely on program designers to write the programs to meet the requirements. Thereafter, the program designers need to verify the program, and the results will then be sent back to the ordinary engineers. As a result, the process efficiency decreases during the modification of the PTP, which incurs extra cost and time.

### SUMMARY OF THE INVENTION

The main objective of the present invention is to provide an open architecture PTP interface where vendors can easily insert in vendor-defined commands.

The other objective of the present invention is to provide a method for inserting vendor-defined commands in the open architecture PTP interface.

To achieve the aforementioned objectives, the present invention provides an open architecture PTP interface which can be applied to a digital device's operational interface. This allows system development companies or related vendors to insert or modify vendor-defined commands by themselves. The open architecture PTP interface provided by the present invention has a hierarchical architecture composed of three layers. The upper layer is the command interpreter module, which is used for executing standard commands or vendor-defined commands; the middle layer is the command manager module and is used for inserting or deleting standard commands or vendor-defined commands; and the bottom layer is the command set module which is used for classifying and storing the standard commands or the vendor-defined commands.

The present invention also provides a method which utilizes the above mentioned interface for inserting vendor-defined commands, comprising the following steps: entering vendor-defined commands; classifying the vendor-defined commands; storing the vendor-defined commands separately from the standard commands; and executing the vendor-defined commands. Wherein, the vendor-defined commands are entered through software programming or via graphic user interface (GUI).

As a result, the lack of frame work and operation inconvenience of the operational interface in the prior technologies can be solved via the present invention's open architecture PTP interface and likewise via its operating method.

### BRIEF DESCRIPTION OF THE DRAWINGS

FIG. 1 is an interface structural diagram of a digital device in accordance with the present invention.

FIG. 2 is a structural diagram of a command interpreter module in accordance with the present invention.

FIG. 3 is a structural diagram of a command manager module in accordance with the present invention.

FIG. 4 is a procedural flow chart of a vendor-defined command inserting method in accordance with the present invention.

FIG. 5 is a structural diagram of a program code generating tool in accordance with the present invention.

### DETAILED DESCRIPTION OF THE PREFERRED EMBODIMENT

Other advantages and innovative features of the invention will become more apparent from the following detailed description when taken in conjunction with the accompanying drawings.

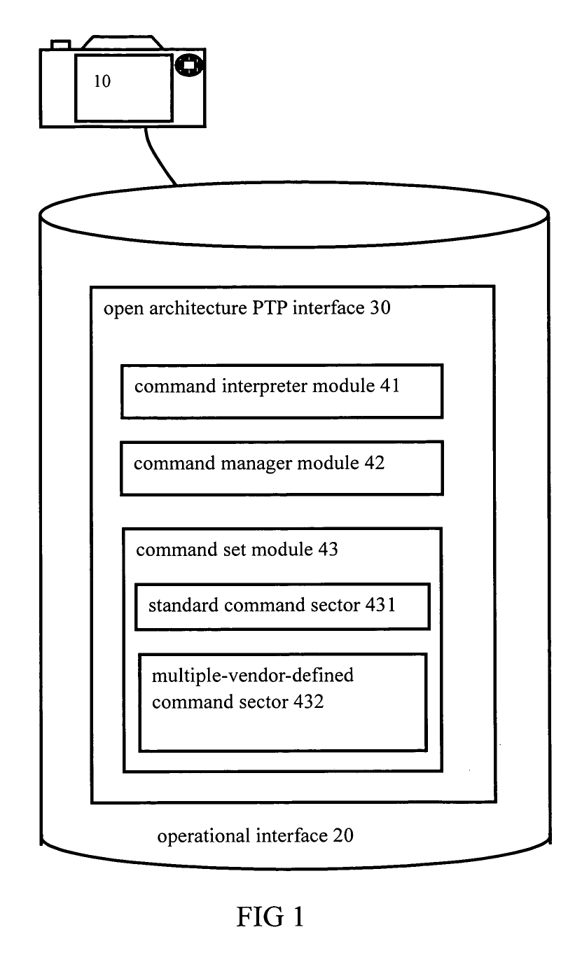

Please refer to FIG. 1, which shows an interface structural diagram of a digital device 10 for the present invention. As shown in FIG. 1, the present invention provides an open architecture PTP interface 30 which is applied on an operational interface 20 of a digital device 10 (in the preferred embodiment, digital device 10 refers to a digital camera, but the present invention is not limited to this device). The open architecture PTP interface 30 is a hierarchical architecture consisting of three layers: an upper layer, a middle layer and a bottom layer; wherein the upper layer is a command interpreter module 41, the middle layer is a command manager module 42, and the bottom layer is a command set module 43.

Usually, during the manufacturing and designing process of the digital device 10, the related vendors such as the system development companies or program development companies, sometimes require to insert additional vendor-defined commands apart from the original standard commands to verify the various hardware functions of the digital device 10, or to add in new functions. Via the present invention, related vendors can easily develop additional vendor-defined commands or instructions, and it makes the management of the vendor-defined commands/instructions and the standard commands more convenient.

As depicted in FIG. 1, the present invention's open architecture PTP interface 30 utilizes the command interpreter module 41 to execute standard commands or vendor-defined commands; utilizes the command manager module 42 to insert or to remove the standard/vendor-defined commands; and utilizes the command set module 43 to classify and to store the standard commands or the vendor-defined commands. Wherein, the command set module 43 comprises a standard command sector 431 and a multiple-vendor-defined command sector 432. The standard command sector 431 is used for storing standard commands, and the multiple-vendor-defined command sector 432 is used for storing different vendor-defined commands.

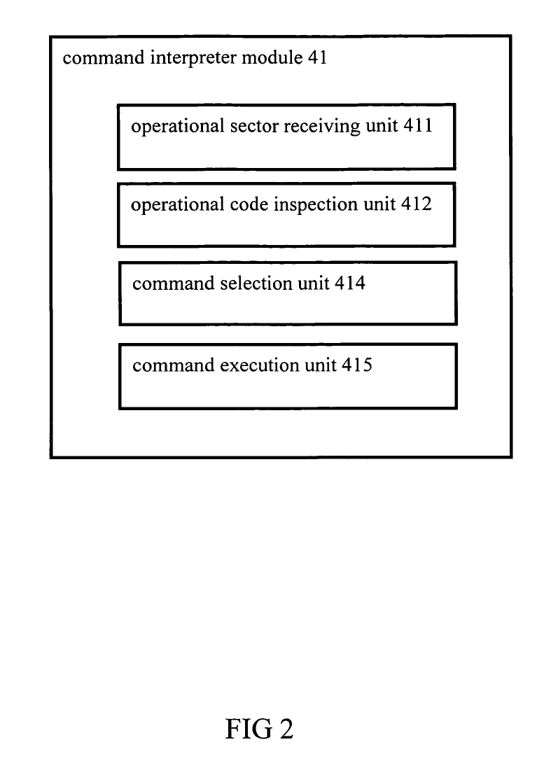

Next, please refer to FIG. 2, which shows a structural diagram of the command interpreter module 41 for the present invention. As depicted in FIG. 2, the command interpreter module 41 comprises an operational sector receiving unit 411, which is used for receiving command sectors; an operational code inspection unit 412, which is used for identifying whether a command sector is a standard command or a vendor-defined command; a command selection unit 414, which is used for selectively executing between the standard commands or the vendor-defined commands; and a command execution unit 415, which is used to execute the standard commands or the vendor-defined commands.

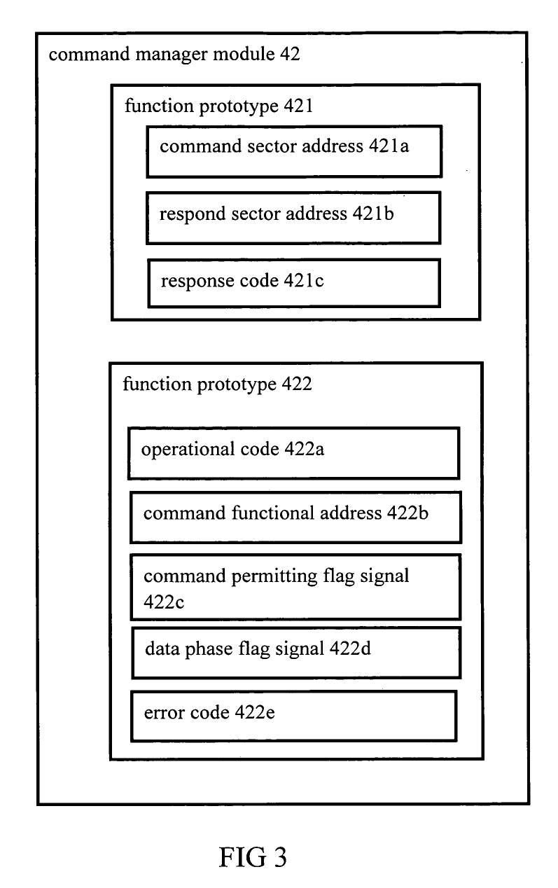

Next, please refer to FIG. 3, which shows a structural diagram of the command manager module 42 for the present invention. As depicted in FIG. 3, the command manager module 42 comprises a function prototype 421 for the standard commands and a function prototype 422 for the vendor-defined commands. Wherein, the function prototype 421 is used for declaring command sector address 421a, respond sector address 421b, and to return response code 421c. The function prototype 422 is used for declaring operational code 422a, command functional address 422b, command permitting flag signal 422c and data phase flag signal 422d, and to return error code 422e.

The present invention not only provides the open architecture PTP interface 30, it also provides a method for inserting the vendor-defined commands, which can be used for the open architecture PTP interface 30 to insert vendor-defined commands.

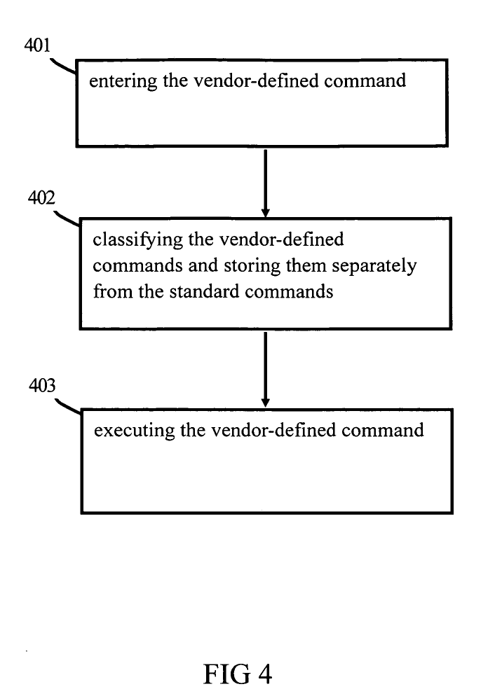

Please refer to FIG. 4, which shows a procedural flow chart of a vendor-defined commands inserting method for the present invention. As depicted in FIG. 4, the method of inserting vendor-defined commands comprises the following steps:

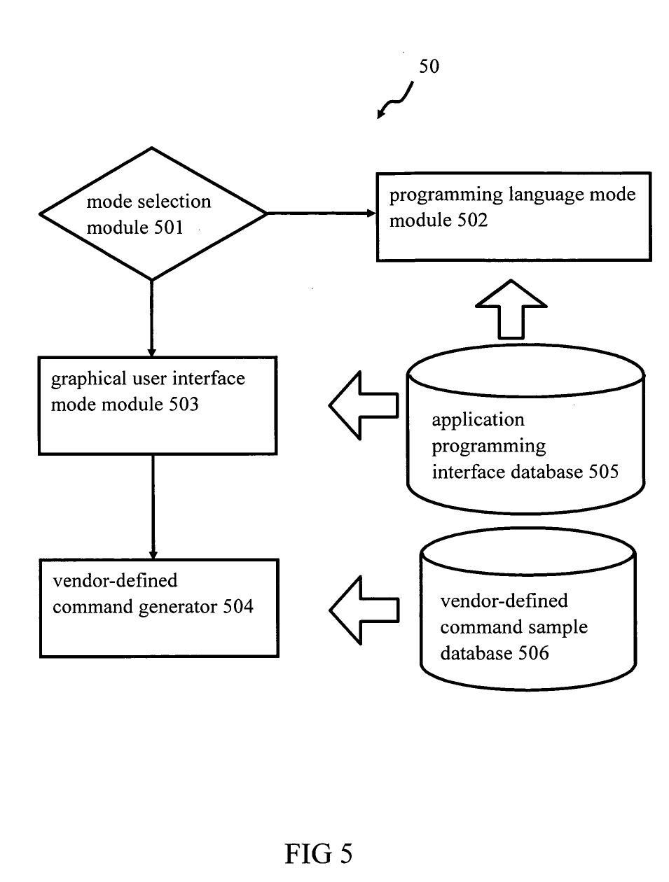

Step 401: Entering the vendor-defined commands. In step 401, the present invention is able to capture the vendor-defined commands via a code-generator tool 50 as depicted in FIG. 5, which will be discussed in detail in subsequent passage.

Step 402: Classifying the vendor-defined commands, and storing them separately from the standard commands, which means the vendor-defined commands are stored in the multiple-vendor-defined command sector 432 of the command set module 43, so that it can be distinguished from the standard commands located in the standard command sector 431.

Step 403: Executing the vendor-defined commands. Step 403 utilizes the command interpreter module 41 to execute the vendor-defined commands, which comprises the following steps: utilizing the operational sector receiver unit 411 to receive command sectors, utilize the operational code inspection unit 412 to identify whether a command sector is a standard command or a vendor-defined command, and utilize the command selection unit 414 to execute the vendor-defined commands prescribed by the operational code 422a.

Lastly, refer to FIG. 5 which shows a structural diagram of a program code generating tool for the present invention. As depicted in FIG. 5, the program code generating tool 50 comprises a mode selection module 501, a programming language mode module 502, a graphical user interface mode module 503, a vendor-defined command generator 504, an application programming interface (API) database 505 and a vendor-defined command sample database 506.

As depicted in FIG. 5, when vendors want to develop vendor-defined commands, they can select either to utilize the programming language mode module 502 or the graphical user interface mode module 503 via the mode selection module 501 to execute the command insertion process. When programming language mode module 502 is chosen for command insertion, the process of retrieving previous files, establishing and editing of new files has to be performed by someone who is familiar with the programming language (e.g. software programmer). When graphical user interface mode module 503 is chosen for command insertion, the insertion process can be performed by someone who is not familiar with the program design language (e.g. ordinary engineers or even ordinary users), which enables them to process with related processes via the graphical user interface and the vendor-defined command generator 504.

Moreover, the API database 505 of the present invention can be used for supporting the programming language mode module 502 or the graphical user interface mode module 503. Furthermore, the vendor-defined command sample database 506 can be used for supporting the vendor-defined command generator 504.

Although the present invention has been explained in relation to its preferred embodiment, it is to be understood that many other possible modifications and variations can be made without departing from the principle and scope of the invention as hereinafter claimed.

What is claimed is:

1. An open architecture picture transfer protocol (PTP) interface, which is used on an operation interface of a digital device for enabling a vendor to develop or modify vendor-defined commands, the open architecture PTP interface comprising:
a command interpreter module, which is used for executing standard commands or the vendor-defined commands;
a command manager module, which is used for inserting or removing the standard commands or the vendor-defined commands; and
a command set module, which is used for classifying the standard commands or the vendor-defined commands.

2. The open architecture PTP interface as claimed in claim 1, wherein the digital device is a digital camera.

3. The open architecture PTP interface as claimed in claim 1, wherein the open architecture PTP interface is a hierarchical architecture comprising an upper layer, a middle layer and a bottom layer; wherein the upper layer is the command interpreter module, the middle layer is the command manager module, and the bottom layer is the command set module.

4. The open architecture PTP interface as claimed in claim 1, wherein the command interpreter module comprising:
an operational sector receiving unit, which is used for receiving command sectors;
an operational code inspection unit, which is used for inspecting whether the command sectors are the standard commands or the vendor-defined commands;
a transaction-ID inspection unit, which is used for inspecting the command sectors to determine if there is an increment in a transaction-ID;
a command selection unit, which uses operational codes for selectively executing either the standard commands or the vendor-defined commands; and
a command execution unit, which executes the standard commands or the vendor-defined commands.

5. The open architecture PTP interface as claimed in claim 1, wherein the command manager module comprises:
a function prototype for the standard commands, which is used for declaring a command sector address and a response sector address; and
a function prototype for the vendor-defined commands, which is used for declaring a operational code, a command function address, a command permitting flag signal and a data phase flag signal.

6. The open architecture PTP interface as claimed in claim 1, wherein the command set module comprises:
a standard command sector, which comprises the standard commands;
and a multiple-vendor-defined command sector, which comprises the vendor-defined commands.

7. A method for inserting vendor-defined commands in an open architecture PTP interface for a digital device, the method comprising the following steps:
entering at least one vendor-defined command;
classifying the at least one vendor-defined command so that it would be stored separately from the at least one standard command; and
executing the at least one vendor-defined command.

8. The method for inserting vendor-defined commands as claimed in claim 7, wherein the at least one vendor-defined command is entered in through software programming or via input from a graphic user interface (GUI).

9. The method for inserting vendor-defined commands as claimed in claim 7, wherein the execution of the at least one vendor-defined command comprising the following steps:
receiving a command sector;
inspecting whether the command sector belongs to the at least one standard command or the at least one vendor-defined command;
inspecting the command sector to determine if there is an increment in a transaction-ID; and
utilizing an operational code to select the execution of the at least one vendor-defined command.

10. A program code generating tool, which allows vendor-defined commands to be inserted onto an open architecture PTP interface, the program code generating tool comprising:
a mode selection module, which is used for selecting either a programming language mode or a graphic user interface (GUI) mode, to insert the vendor-defined commands;
a programming language mode module, which is used for inserting the vendor-defined commands via the programming language mode;
a GUI mode module, which is used for inserting the vendor-defined commands via the GUI mode; and
a vendor-definition command generator, which is used in the GUI mode for generating the vendor-defined commands.

11. The program code generating tool as claimed in claim 10 further comprises an application programming interface (API) database, which is used for supporting the programming language mode or the GUI mode, to generate a application program which is required by the vendor-defined commands.

12. The program code generating tool as claimed in claim 10 further comprises a vendor-definition command sample database, which is used for supporting the vendor-defined command generator to generate the vendor-defined commands.
